(19) United States
(12) Patent Application Publication
(10) Pub. No.: US 2009/0034496 A1
(43) Pub. Date: Feb. 5, 2009

(54) PACKET DATA PROTOCOL CONTEXT MANAGEMENT METHOD FOR A MOBILE STATION

(75) Inventors: Ha Yoon KO, Suwon-si (KR); Yong Seock CHOI, Seoul (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/144,287

(22) Filed: Jun. 23, 2008

(30) Foreign Application Priority Data
Jul. 31, 2007 (KR) 2007-0076870

(51) Int. Cl. H04Q 7/00

(52) U.S. Cl. 370/338

(57) ABSTRACT

A packet data protocol (PDP) context management method is provided. The PDP context management method enables a mobile station to manage the PDP contexts of networks integrally by evaluating PDP context capacities of the networks in a proactive manner. A packet service method of the present invention includes creating a network information table after activating a packet data protocol (PDP) context to a network, determining, when a multiple PDP context activation is requested, whether the network has a multiple PDP context capacity with reference to the network information table, requesting, if the network has a multiple PDP context capacity, a multiple PDP context activation to the network and stopping, if the network has a multiple PDP context capacity, attempt of a multiple PDP context activation to the network.

### PRIORITY

This application claims the benefit under 35 U.S.C. § 119(a) of a Korean patent application filed in the Korean Intellectual Property Office on Jul. 31, 2007 and assigned Serial No. 2007-0076870, the entire disclosure of which is hereby incorporated by reference.

### BACKGROUND OF THE INVENTION

1. Field of the Invention

The present invention relates to a mobile communication system. More particularly, the present invention relates to a Packet Data Protocol (PDP) context management method for a mobile communication system that enables a mobile station to manage the PDP contexts of networks integrally by evaluating PDP context capabilities of the networks in a proactive manner.

2. Description of the Related Art

Typically, in order for a mobile station to use a packet service in a General Packet Radio Service/Wideband Code Division Multiple Access (GPRS/WCDMA) network, a connection is established between the mobile station and an external Packet Data Network (PDN) through a PDP context activation procedure. After the session is successfully established, the mobile station can exchange data with a counterpart terminal connected to the PDN using Transmission Control Protocol/Internet Protocol (TCP/IP).

FIG. 1 is a message flow diagram illustrating a PDP context activation procedure in a conventional mobile communication system. The PDP context activation procedure is specified in the 3rd Generation Partnership Project (3GPP) standards.

Referring to FIG. 1, the Mobile Station (MS) 200 initiates the PDP context activation by sending an ACTIVATE_PDP_CONTEXT_REQUEST message to the network 300 in step S101. At this time, the MS 200 starts a timer. If no response is received from the network 300 before the timer expires, the MS 200 determines that an error has occurred.

Upon receipt of the ACTIVATE_PDP_CONTEXT_REQUEST message, the network 300 performs a PDP context creation process. If a PDP context is successfully created, the network 300 sends an ACTIVATE_PDP_CONTEXT_ACCEPT message to the MS 200 in step S103. On the other hand, if the PDP context creation process fails, the network 300 sends an ACTIVATE_PDP_CONTEXT_REJECT message to the MS 200 in step S105.

In the case that the PDP context is successfully created such that the PDP context is activated between the MS 200 and the network 300, this PDP context is called a primary PDP context.

If another connection which requires different Quality of Service (QoS) using the same Access Point Name (APN) with the primary PDP context is requested, the MS 200 activates a secondary PDP context dependent on the primary PDP context. Here, the APN is a name of the IP network to which the MS 200 is connected. The APN is used to query the Domain Name System (DNS) to get the IP address of a gateway serving for the APN. That is, the APN is a type of domain name. The QoS is a control mechanism for guaranteeing priority and performance required by a user.

In a case that a connection using another APN different from that of the primary PDP context is requested, the MS 200 activates another primary PDP context regardless of the previously activated PDP context to the network 300. Such an environment, in which two or more primary PDP contexts are activated, is called a multiple PDP context environment.

In the case of a 2nd generation (2G) network such as GPRS and Enhanced Data rates for Global Evolution (EDGE), most of the carrier networks support multiple PDP context activations. However, the 3G networks such as Universal Mobile Telecommunications System (UMTS) do not support multiple PDP context activation yet. Accordingly, a determination is made regarding activation of the multiple PDP context function, wherein the determination is dependent on the generation of the MS (i.e. 2G or 3G). The reasons why the multiple PDP context activation function is selectively supported are as follows.

In a network that does not support multiple PDP context activation, a multiple PDP context activation attempt fails in the following cases:

(A) When the network does not send a response (Accept/Reject) to the MS since the network has no capacity to process the multiple context activation request, and

(B) The network rejects the multiple PDP context activation request and reports the rejection result to the MS.

In case (A), the MS does not receive the multiple PDP context activation response (Accept/Reject) before the timer, explained with reference to FIG. 1, has expired such that the MS performs an error handling procedure. In case (B), the MS performs an error handling procedure corresponding to the reject cause and outputs the result through a user interface (UI).

With respect to the above error situations, the conventional 3GPP standard does not specify a method for notifying the MS that the network does not have a capacity to support the multiple PDP contexts. Accordingly, in view of the fact that the MS has no way to notify the user that the error has occurred by the incapacity of the network, the user is likely to misunderstand that the problem is caused by the MS.

For these reasons, the ability of an MS to support the multiple PDP context function is fixedly configured in the MS's software at the time when the MS is deployed in the market, depending on whether the carrier network has a multiple PDP context activation capacity. That is, the MS is configured to support the multiple PDP context function when the carrier network of the MS is a 2G network, and configured not to support the multiple PDP context function when the carrier network of the MS is a 3G network.

However, it is possible that a 3G network may evolve to support the multiple PDP context activation. In such a case, if a subscriber uses an MS in which a multiple PDP context function is locked, the multiple PDP context function of the MS becomes useless, thereby abandoning utilization of useful network resource and capacity, resulting in a waste of resources.

Such emasculation of the useful function of the MS causes an inconvenience for the MS user. Furthermore, the blame for such inconvenience is likely to be put on the manufacturer. One potential solution is to activate the multiple PDP context function of the MS through a firmware upgrade. However, in order to upgrade the firmware, the user must visit a service center, which causes further inconvenience and causes additional cost to the user.

### SUMMARY OF THE INVENTION

An aspect of the present invention is to address at least the above-mentioned problems and/or disadvantages and to provide at least the advantages described below. Accordingly, an aspect of the present invention is to provide a PDP context management method that enables a mobile station to determine the multiple PDP context activation capacity of a network.

Another aspect of the present invention is to provide a PDP context management method that enables a Mobile Station (MS) to determine the multiple PDP context activation capacity of a network and perform a multiple PDP context activation procedure in proactive manner by improving initial PDP context activation procedure between the MS and the network.

Still another aspect of the present invention is to provide a PDP context management method that is capable of maximizing resource utilization and capacities of multiple PDP context-supportable networks and reducing multiple PDP context activation errors by preventing multiple PDP context-unsupportable networks from attempting the multiple PDP context activation.

In accordance with an aspect of the present invention, a packet service method of a mobile station is provided. The method includes creating a network information table after activating a Packet Data Protocol (PDP) context to a network, determining, when a multiple PDP context activation is requested, whether the network has a multiple PDP context capacity with reference to the network information table, requesting, if the network has a multiple PDP context capacity, a multiple PDP context activation to the network and stopping, if the network does not have a multiple PDP context capacity, an attempt of a multiple PDP context activation to the network.

In accordance with another aspect of the present invention, a packet service method for a mobile station is provided. The method includes sending, by the mobile station, a Packet Data Protocol (PDP) context activation request message to a network, determining, if a PDP context activation response message is received in response to the PDP context activation request message, whether the PDP context activation response message contains capacity information of the network, outputting, if the PDP context activation response message does not contain capacity information, notification of success or failure of a PDP context activation through a user interface, outputting, if the PDP context activation response message contains capacity information, notification of success or failure of a PDP context activation and storing the capacity information in a network information table and updating the network information table by adding a result of the PDP context activation.

In accordance with yet another aspect of the present invention, a packet service method is provided. The packet service method includes sending, by a mobile station, a Packet Data Protocol (PDP) context activation request message containing a parameter requesting a PDP context status to a network, sending, by the network, a PDP context accept/reject message containing a PDP context status information to the mobile station, storing, at the mobile station, the PDP context status information from the PDP context accept/reject message transmitted by the network in a network information table and determining, when a multiple PDP context activation request is detected, whether to attempt a multiple PDP context activation to the network with reference to the PDP context status information of the network in the network information table.

In accordance with still another aspect of the present invention, a packet service system is provided. The packet service system includes a mobile station having a network information table containing capacity information of networks for determining whether to attempt a multiple Packet Data Protocol (PDP) context activation to a network with reference to the network information table and a network for sending a PDP context activation accept/reject message containing PDP context capacity information to the mobile station in response to a PDP context activation request message transmitted by the mobile station.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 is a message flow diagram illustrating a PDP context activation procedure in a conventional mobile communication system;

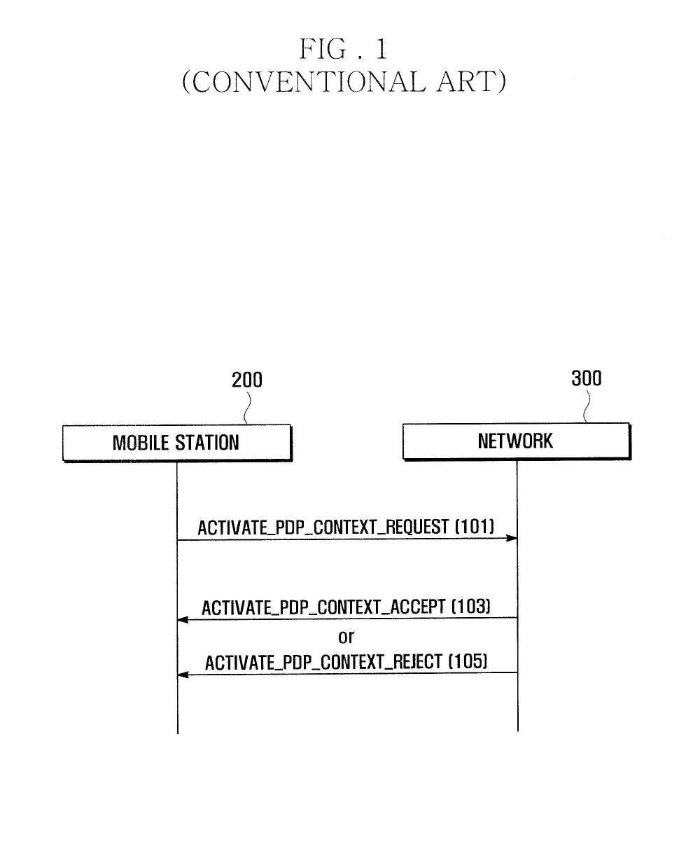

FIG. 2 is a message flow diagram illustrating a PDP context activation procedure of a PDP context management method according to an exemplary embodiment of the present invention;

FIG. 3 is a flowchart illustrating a multiple PDP context activation procedure of a PDP context management method according to an exemplary embodiment of the present invention;

FIG. 4 is a flowchart illustrating a PDP context capacity notification procedure of a PDP context management method according to an exemplary embodiment of the present invention; and

FIG. 5 is a block diagram illustrating a configuration of a mobile station according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and phrases used in the specification and appended claims are provided to enable a clear and consistent understanding of the detailed description and the claims. Unless otherwise noted, the terms and phrases are to be understood according to conventional usage by those skilled in the relevant art. While the invention is shown and described with reference to certain exemplary embodiments thereof, it will be understood by those skilled in the art that various changes in form and details may be made therein without departing from the spirit and scope of the invention as defined by the appended claims and their equivalents.

In the following, a Packet Data Protocol (PDP) context management method is described with reference to certain exemplary embodiments. A multiple PDP context activation procedure allows a Mobile Station (MS) to establish multiple individual sessions with multiple Packet Data Networks (PDNs) such that the MS can exchange data through the individual channels without interference from each other. The multiple PDP context activation is advantageous in that the MS can use a new service without breaking the previously established connection with the network. In the following exemplary embodiments, the MS determines the PDP context activation capability of a network and avoids an error caused by an invalid PDP context activation attempt, thereby improving the utilization of a multiple PDP context activation function.

In the following exemplary embodiments, the PDP context activation procedure between the MS and network specified in the communication standard is improved such that the MS determines the PDP context capacity of the network. With this improvement, the MS can control the PDP context activation procedure in a proactive manner.

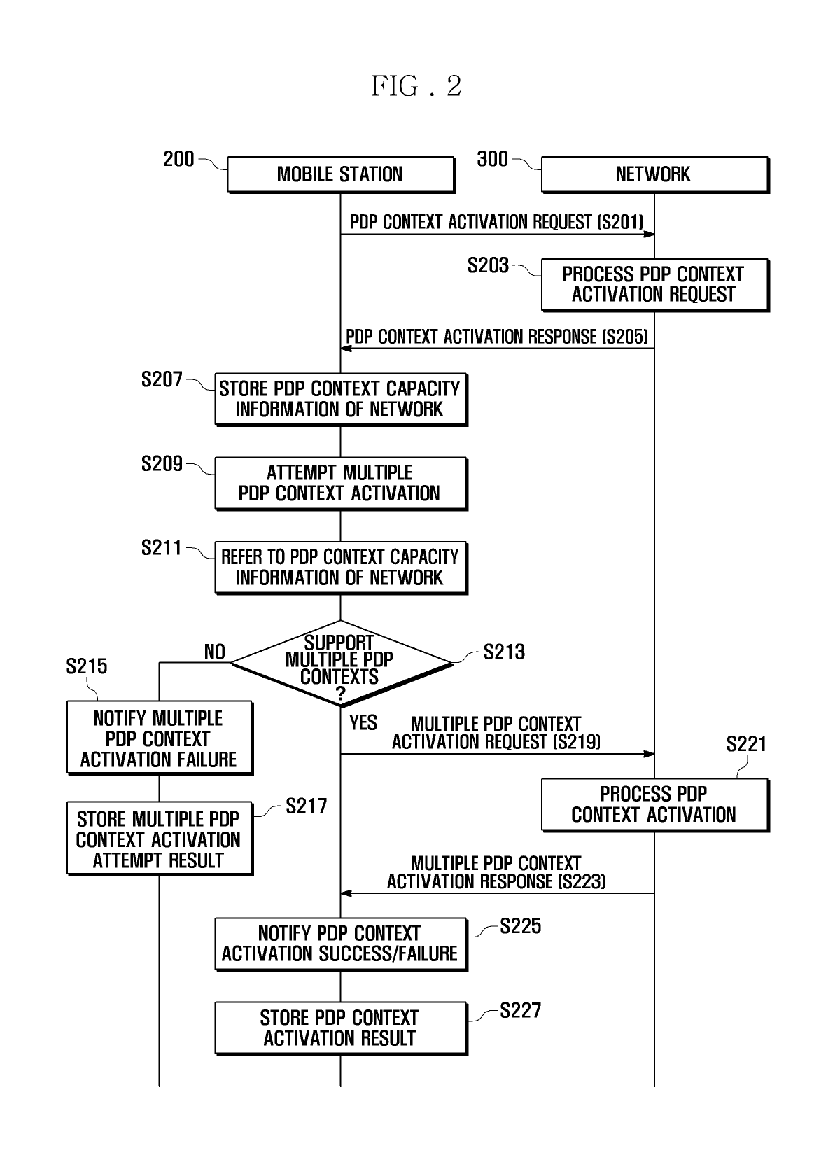

FIG. 2 is a message flow diagram illustrating a PDP context activation procedure of a PDP context management method according to an exemplary embodiment of the present invention.

Referring to FIG. 2, an MS 200 transmits a PDP context request (ACTIVATE_PDP_CONTEXT_REQUEST) message in step S201. In an exemplary implementation, the PDP context request message is sent after the MS is associated with the network. However, the request message may be sent concurrently with the association. In the exemplary embodiment, the ACTIVATE_PDP_CONTEXT_REQUEST message may include a field for requesting the PDP context capacity of the network. The ACTIVATE_PDP_CONTEXT_REQUEST message specified in the standard is structured as shown in Table 1 and is extended as shown in Table 2.

TABLE 1

| | | | | | |
|---|---|---|---|---|---|
| 27 | Protocol configuration | Protocol configuration | O | TLV | 3-253 |
| | options | option 10.5.6.3 | | | |

TABLE 2

| | |
|---|---|
| Container ID n | octet y + 1 |
| | octet y + 2 |
| Length of container ID n contents | octet y + 3 |
| Container ID n contents | octet y + 4 |
| | octet z |

In this exemplary embodiment, the MS 200 sends the ACTIVATE_PDP_CONTEXT_REQUEST message containing the information of Table 2 to the network 300. Here, the container ID of Table 2 can be set to a new value as follows:
0001H (P-CSCF Address Request);
0002H (IM CN Subsystem Signaling Flag);
0003H (DNS Server Address Request);
0004H (Not Supported); and
0008H (PDP context capacity information request)

Particularly, the value “0008H” of the container ID is used for requesting the PDP context capacity supported by the current network. Simultaneously, the MS 200 starts a timer. If no reply is received from the network 300 before the expiration of the timer, the MS 200 performs an error handling procedure. The PDP context activation error handling procedure is described later.

Returning to FIG. 2, upon receipt of the ACTIVATE_PDP_CONTEXT_REQUEST message, the network 300 attempts to activate the PDP context requested by the MS 200 in step S203 and replies with a PDP context response message in step S205. The PDP context response message can be any of an ACTIVATE_PDP_CONTEXT_ACCEPT message and ACTIVATE_PDP_CONTEXT_REJECT message.

That is, if the requested PDP context is successfully activated, the network 300 replies with the ACTIVATE_PDP_CONTEXT_ACCEPT message and, otherwise, with the ACTIVATE_PDP_CONTEXT_REJECT message. The ACTIVATE_PDP_CONTEXT_ACCEPT message and ACTIVATE_PDP_-CONTEXT_REJECT message are commonly structured as shown in Table 3.

TABLE 3

| | | | | | |
|---|---|---|---|---|---|
| 27 | Protocol configuration | Protocol configuration | O | TLV | 3-253 |
| | options | option 10.5.6.3 | | | |

If the requested PDP context is not successfully activated, the ACTIVATE_PDP_CONTEXT_REJECT message is extended to have information shown in Table 4.

TABLE 4

| | |
|---|---|
| Container ID n | octet y + 1 |
| | octet y + 2 |
| Length of container ID n contents | octet y + 3 |
| Container ID n contents | octet y + 4 |
| | octet z |

In this exemplary embodiment, the network 300 sends the ACTIVATE_PDP_CONTEXT_REJECT message containing the information of Table 4 to the MS 200. Here, the container ID of Table 4 can be set to a new value as follows:
0001H (P-CSCF Address);
0002H (IM CN Subsystem Signaling Flag);
0003H (DNS Server Address);
0004H (Policy Control rejection code); and
0008H (PDP context capacity information response)

Particularly, the value “0008H” of the container ID set with the ACTIVATE_PDP_CONTEXT_ACCEPT message and ACTIVATE_PDP_-CONTEXT_REJECT message is used for indicating whether the network 300 can support the requested PDP context.

If the container ID is set to 0008H, the content of 0008H of the ACTIVATE_PDP_CONTEXT_ACCEPT message and ACTIVATE_PDP_-CONTEXT_REJECT message can be defined as shown in Table 5.

TABLE 5

8 7 6 5 4 3 2 1

| | |
|---|---|
| Max number of PDP contexts | Max number of concurrent |
| supported by Network | Primary PDP contexts |
| | supported by Network |

In Table 5, the “Max number of PDP contexts supported by Network” field indicates the total number of PDP contexts including Primary PDP contexts and Secondary PDP contexts that can be simultaneously activated by the network 300, and “Max number of current Primary PDP contexts supported by Network” field indicates the number of Primary PDP contexts that can be simultaneously activated by the network 300.

Using the parameters defined in Table 5, the network 300 informs the MS 200 of its multiple PDP context capacity. For example, if the “Max number of concurrent Primary PDP context supported by Network” is set to equal to or less than 1, it means that the network 300 does not support the multiple PDP contexts and, otherwise, it means that the network 300 supports multiple PDP contexts.

Upon receiving the PDP context response, the MS 200 extracts information on the PDP context capacity of the network 300 from the PDP context response and stores the PDP context capacity information in step S207. The MS 200 can recognize whether the network 300 supports the multiple PDP context activation with reference to the PDP context capacity information. That is, the MS 200 can recognize how many Secondary PDP contexts per Primary PDP context are supported by determining the values of the “Max number of PDP context supported by Network” field and the “Max number of concurrent Primary PDP contexts supported by Network” shown in Table 5. The MS 200 stores the PDP context capacity information in the form of Table 6 and, when attempting to request the PDP context activation, determines whether to request the multiple PDP context activation to the network.

After the PDP context activation procedure is successfully performed, the MS 200 detects a multiple PDP context activation request attempt by the user in step S209. If a multiple PDP context activation request attempt is detected, the MS 200 refers to the PDP context capacity information of the network 300 stored in the form of Table 6 in step S211 and determines whether the network 300 supports the Multiple PDP context activation function in step S213.

If it is determined that the network 300 does not support the multiple PDP context activation function, the MS 200 notifies the user that the network 300 does not support the multiple PDP context activation function through a user interface in step S215. Next, the MS 200 stores the multiple PDP context activation attempt result in the form of Table 6 in step S217.

In contrast, if it is determined that the network 300 supports the multiple PDP context activation function, the MS 200 transmits a multiple PDP context request (ACTIVATE_MULTIPLE_PDP_CONTEXT_REQUEST) message to the network 300 in step S219.

Upon receipt of the ACTIVATE_MULTIPLE_PDP_CONTEXT_-REQUEST message, the network 300 processes the PDP context activation in step S221 and sends the PDP context activation result (ACTIVATE_MULTIPLE_-PDP_CONTEXT_RESPONSE) message to the MS in step S223.

Upon receipt of the ACTIVATE_MULTIPLE_PDP_CONTEXT_-RESPONSE MESSAGE, the MS 200 outputs the PDP context activation result, i.e. whether the PDP context activation succeeds or fails, through the user interface in step S225. The MS 200 then stores the PDP context activation results in the form of Table 6 in step S227.

The following is an exemplary process of storing and using the PDP context activation result and PDP context capacity information described with reference to Table 6.

TABLE 6

| | | | | Max | | |
|---|---|---|---|---|---|---|
| | | | | number of | | |
| | | | | concurrent | | |
| | | | | Primary | | |
| | | | Max number | PDP | | |
| MMC | MNC | | of PDP | contexts | | |
| (Mobile | (Mobile | RAB (Radio | contexts | supported | Multiple | |
| Country | Network | Access Bearer) | supported by | by | PDP | Notified by |
| Code) | Code) | GPRS/WCDMA | Network | Network | supported | Network |
| CCC | NNN | 2G/3G | A(0~n), | B(0~n), | Supported/ | TRUE/FALSE |
| | | | Default: NULL | Default: | Not | |
| | | | | NULL | Supported | |

Table 6 is an exemplary PDP context capacity information table. The information contained in the network information table is maintained until the next power-on cycle. That is, it may be cleared when the MS 200 is turned off. Also, the MS 200 can be configured to maintain the information contained in the network information table regardless of power-on/off, for example by storing the information in a non-volatile memory unit of the MS 200.

As shown in Table 6, the network information table also stores the Mobile Country Code (MCC) and Mobile Network Code (MNC) of the network 300. The values of the MCC and MNC are used for identifying the network.

In this exemplary embodiment, the network information table includes a Radio Access Bearer (RAB) field such that it can be used for a 2G (e.g., GPRS) as well as a 3G system network. In the 2G network environment, the multiple PDP context activation is supported, but the number of available PDP contexts is not managed. In this illustrated example, the number of available PDP contexts is managed such that the PDP context management method can be extended for the 2G network environment. The operation related to the RAB corresponds to the multiple PDP context determination algorithm using the MCC and MNC hereinafter.

As described above, the PDP context capacity information on the network acquired through the PDP context activation and multiple PDP context activation attempts can be updated as follows:
(1) In a case that the network information table contains records of which MCC and MNC fields are identical with each other, the corresponding fields are updated.
(2) In a case that the network information table contains no records of which MCC and MNC fields are identical with each other, the update can be performed by creating new records. An exemplary method of updating the network information table is described hereinafter in more detail.

First, an example of how the network information table is updated by a PDP context activation is described.

If a PDP context activation is attempted, then all the fields of the PDP context capacity information table, i.e., the <MCC>, <MNC>, <Max number of PDP contexts supported by Network>, <Max number of concurrent Primary PDP contexts supported by Network>, <Multiple PDP supported>, and <notified by network> fields, are updated.

At this time, if the value of the <Max number of concurrent Primary PDP contexts supported by Network> field is equal to or less than 1, <Multiple PDP supported> field is set to “not supported” and, otherwise, <multiple PDP supported> field is set to “supported. In this case, the <notified by network> field is set to “TRUE”.

Next, an example of how the network information table is updated by a multiple PDP context activation is described.

If a multiple PDP context activation is attempted, the <MCC>, <MNC>, <Multiple PDP supported>, and <notified by network> fields of the table are updated.

At this time, the <Max number of PDP contexts supported by Network> and <Max number of concurrent Primary PDP contexts supported by Network> fields are set to NULL. In this case, the <notified by network> field is set to FALSE.

An exemplary process for multiple PDP context activation using the network information table as Table 6 is described hereinafter.

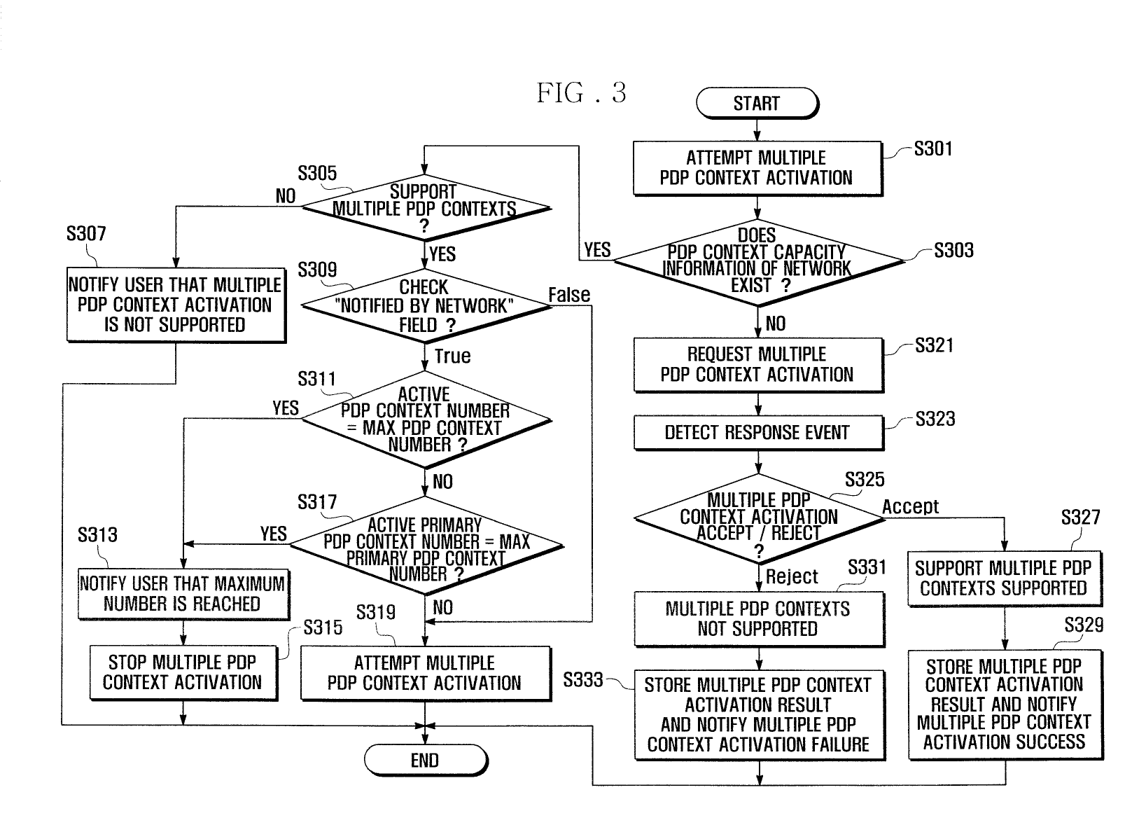

FIG. 3 is a flowchart illustrating a multiple PDP context activation procedure of a PDP context management method according to an exemplary embodiment of the present invention. In FIG. 3, the multiple PDP context activation procedure is described with the use of a network information table (see Table 6) created of the basis of a result of the MS's PDP context activation attempt and the network PDP context capacity information. Accordingly, in FIG. 3, it is assumed that a PDP context is activated between the MS and the network. The information of the network information table can be referred to when the user requests multiple PDP context activation.

Referring to FIG. 3, if it is detected in step S301 that a multiple PDP context activation attempt is made to a network while a PDP context is activated with the network, the MS determines whether the network information table contains PDP context capacity information of the network in step S303. The MS retrieves the PDP context capacity information by determining the MMC and MNC fields of the network information table.

If the PDP context capacity information of the network exists, i.e. the MMC and MNC of the network are retrieved in the network information table, the MS determines whether the network supports the multiple PDP context activation with reference to the PDP context capacity information of the network in step S305.

If it is determined that the network does not support multiple PDP context activation, the MS stops the multiple PDP context activation procedure to the network and notifies the user that the network does not support the multiple PDP context activation in step S307. At this time, the MS may disconnect the previous connection to the network and display a dialog box asking whether to activate a new PDP context and execute a next operation according to the user selection.

In contrast, if it is determined that the network supports the multiple PDP context activation, the MS determines the value of the “notified by network” field in step S309. If the “notified by network” field is set to “FALSE”, the MS performs the multiple PDP context activation in step S319. On the other hand, if the “notified by network” field is set to “TRUE”, the MS compares a number of the currently activated PDP contexts and a number of the PDP contexts supported by the network in step S311. Here, the number of PDP contexts supported by the network can be acquired with reference to the “Max number of PDP contexts supported by Network” field of the network information table.

As a result of the comparison, if the number of the currently activated PDP contexts is equal to the value of the “Max number of PDP contexts supported by Network” field, the MS notifies the user that the number of activated PDP contexts has reached the maximum number in step S313 and stops the multiple PDP context activation procedure in step S315.

If the number of the currently activated PDP contexts is less than the value of the “Max number of PDP contexts supported by Network” field, the MS compares the number of currently activated primary PDP contexts and a number of Primary PDP contexts that are concurrently supported by the network in step S317. Here, the number of Primary PDP contexts supported by the network can be acquired with reference to the “Max number of concurrent Primary PDP contexts supported by Network” field of the network information table.

If the number of the currently activated Primary PDP contexts is equal to the value of the “Max number of concurrent Primary PDP contexts supported by Network” field, the MS notifies the user that the number of currently activated Primary PDP contexts has reached the maximum number in step S313 and stops the Primary multiple PDP context activation procedure in step S315.

On the other hand, if the number of the currently activated Primary PDP contexts is less than the value of the “Max number of concurrent Primary PDP contexts supported by Network” field, the MS attempts the multiple context activation in step S319.

Referring again to step S303, if the PDP context capacity information of the network does not exist in the network information table, the MS performs a multiple PDP context determination procedure.

That is, the MS requests a multiple PDP context activation to the network in step S321 and detects a response event following the multiple PDP context activation request in step S323. If a response event is detected, the MS analyzes the response event in step S325. The response event may be receipt of a multiple PDP context activation accept messages or multiple PDP context activation reject message or an expiration of a timer.

As a result of the analysis, if a multiple PDP context activation accept message is received, the MS determines that the network supports the multiple PDP context activation function in step S327. Sequentially, the MS records the multiple PDP context activation result (i.e., multiple PDP context activation success information) within the network information table and notifies the user that the multiple PDP context activation to the network has succeeded in step S329.

On the other hand, if a multiple PDP context activation reject message is received from the network or the timer has expired at step S325, the MS determines that the network does not support the multiple PDP context activation function in step S331. Sequentially, the MS records the multiple PDP context activation result (i.e., multiple PDP context activation failure information) within the network information table and notifies the user that the multiple PDP context activation to the network has failed in step S333.

By storing the multiple PDP context activation failure information in the network information table, the MS can determine whether to attempt the multiple PDP context activation to the network with reference to the network information table afterward.

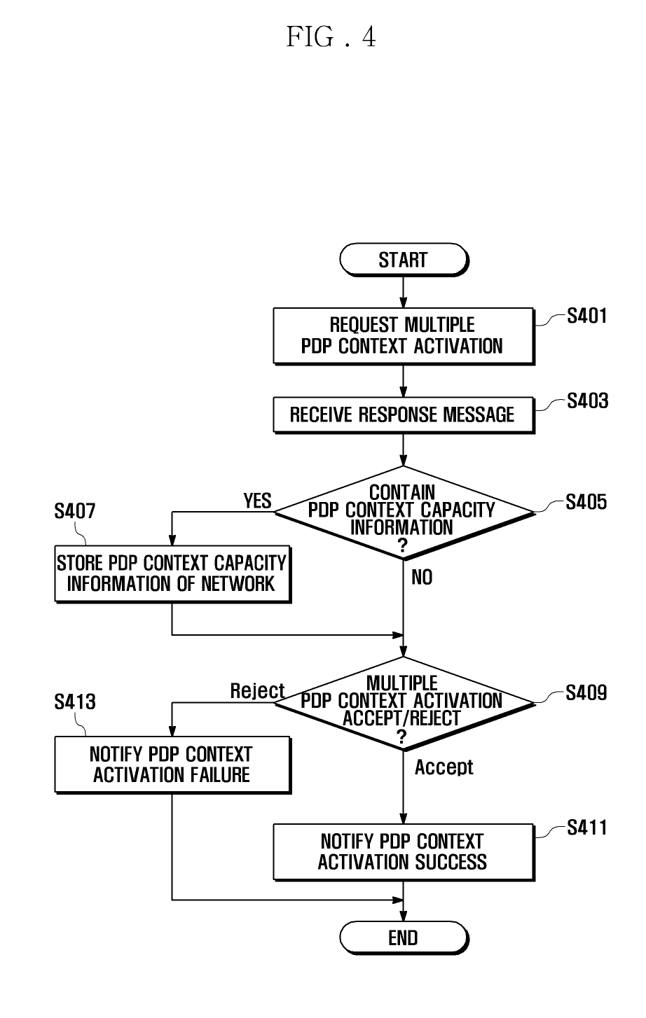

FIG. 4 is a flowchart illustrating a PDP context capacity notification procedure of a PDP context management method according to an exemplary embodiment of the present invention.

Referring to FIG. 4, the MS, first, sends a PDP context activation request (ACTIVATE_PDP_CONTEXT_REQUEST) message to the network after being connected to the current network in step S401. At this time, the ACTIVATE_PDP_CONTEXT_REQUEST message may contain the Container ID set to “0008H” as explained in Table 2. The Container ID set to “0008H” indicates that the message requests PDP context capacity information of the network.

Next, the MS receives a PDP context activation response message from the current network in step S403 and determines whether the PDP context activation response message contains the PDP context capacity information in step S405. The PDP context activation response message can be one of ACTIVATE_PDP_CONTEXT_ACCEPT message and ACTIVATE_PDP_-CONTEXT_REJECT message. Each of the ACTIVATE_PDP_CONTEXT_ACCEPT message and ACTIVATE_PDP_CONTEXT_REJECT message may include the Container ID field set to “0008H” as explained in Table 4. The Container ID set to “0008H” indicates that the message contains the PDP context capacity information of the network.

If it is determined that the PDP context activation response message contains the PDP context capacity information at step S405, the MS stores the PDP context capacity information within the network information table as explained with reference to Table 6 in step S407. After storing the PDP context capacity at step S407, or if it is determined that the PDP context activation response message does not contain the PDP context capacity information at step S405, the MS determines whether the PDP context activation response message is the ACTIVATE_PDP_CONTEXT_ACCEPT message or the ACTIVATE_PDP_-CONTEXT_REJECT message in step S409. The network sends the ACTIVATE_PDP_CONTEXT_ACCEPT message to the MS for indicating acceptance of the PDP context activation or the ACTIVATE_PDP_CONTEXT_-REJECT message for indicating rejection of the PDP context activation. As described above, each of the ACTIVATE_PDP_CONTEXT_ACCEPT message and the ACTIVATE_PDP_CONTEXT_REJECT message may contain the PDP context capacity information.

If the PDP context activation response message is the ACTIVATE_-PDP_CONTEXT_ACCEPT message, the MS notifies the user of the PDP context activation success in step S411. On the other hand, if the PDP context activation response message is the ACTIVATE_PDP_CONTEXT_REJECT message, the MS notifies the user of the PDP context activation failure in step S413.

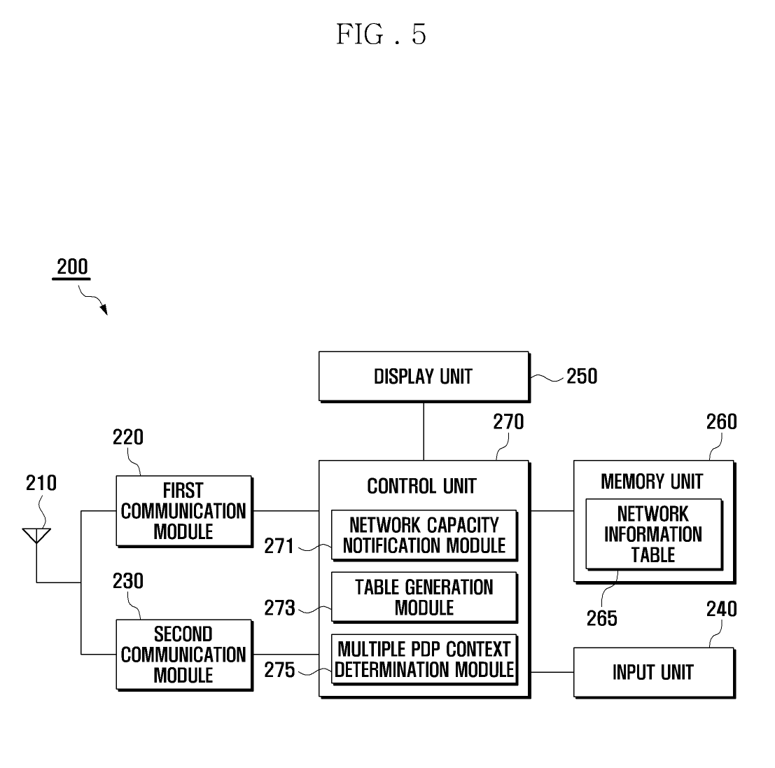

FIG. 5 is a block diagram illustrating a configuration of a mobile station according to an exemplary embodiment of the present invention. According to the illustrated example, the mobile station of FIG. 2 is a dual mode mobile station supporting communications with 2G and 3G communication networks.

Referring to FIG. 5, the mobile station 200 includes an antenna 210, a first communication module 220 responsible for communication with the 2G network, a second communication module 230 responsible for communication with the 3G network, an input unit 240, a display unit 250, a memory unit 260, and a control unit 270.

The antenna 210 is configured to process the signals on the frequency bands of the 2G and 3G networks. Although a single antenna is depicted in FIG. 5, more than 2 antennas can be used.

Each of the first and second communication module 220 and 230 is provided with a duplexer for separating transmission and reception frequencies, a radio frequency (RF) transceiver for processing transmission and reception signals, and a modem for modulating/demodulating the transmission and reception signals.

The input unit 240 receives various alphanumeric information and various function control keys input by a user and transfers key signals corresponding to the key inputs to the control unit 270. The input unit 240 can be implemented with at least one of a touchpad, a keypad, and a qwerty keyboard. Particularly in this embodiment, the input unit 240 is configured to generate a PDP context activation request command in response to a user's key input and transfers the PDP context activation request command to the control unit 270.

The display unit 250 displays a screen image generated while operating an application, key manipulation status, and activated function information. The display unit 250 can be implemented with a Liquid Crystal Display (LCD). In a case that the LCD is implemented with touch screen functionality, the display unit 270 acts as a part of the input unit 240. Particularly in this embodiment, the display unit 270 is configured to display the PDP context activation success/failure information in the PDP context activation procedure.

The memory unit 260 stores application programs associated with the PDP context management method according to an exemplary embodiment of the present invention, user data input by the user, and various application data received from outside. Particularly in this embodiment, the application data received from outside can be the PDP context capacity information of the network to which the mobile station is currently connected. The application programs include at least one software module for providing the network's PDP context capacity notification, generating and storing PDP context capacity information, and determining the multiple PDP contexts. The memory unit 260 may include at least one buffer for buffering user data generated while the applications operate. In an exemplary implementation, the memory unit 260 stores the network information table containing the PDP context capacity information of the networks.

The control unit 270 controls general operations of the mobile station 200 and signaling among the internal components of the mobile station 200. The control unit 270 controls cooperative signaling between the first and second communication modules 220 and 230, input unit 240, display unit 250, and memory unit 260. The control unit 270 may incorporate a modem and a codec.

In a case that the mobile station 200 is located in a coverage area of one of a 2G or a 3G network, the control unit 270 controls a packet service connection using the corresponding one of the first and second communication modules 220 and 230. In a case that the mobile station 200 is located in an overlapping coverage area of the 2G and 3G networks, the control unit 27 controls one of the first and second communication modules 220 and 230 in an order of preset priorities so as to connect to the network of higher priority. The control unit 270 can control the operations of the first and second communication modules 220 and 230 according to the status of packet services of the networks.

In an exemplary implementation, the control unit 270 controls to send a PDP context activation request message having a network capacity request information to the current network in response to a PDP context request command input by the user. The control unit 270 acquires the network capacity information from a PDP context activation response message received in response to the PDP context activation request message and stores the network capacity information in a network information table 265. The control unit 270 controls such that a result of a multiple PDP context activation attempt is notified to the user. The control unit 270 determines the PDP context capacity of the current network by referring to the network information table 265 and determines whether to attempt a multiple PDP context activation to the network.

In order to improve processing efficiency and distribute processing load of the control unit 270, the control unit 270 may include a network capacity notification module 271, a table generation module 273, and a multiple PDP context determination module 275.

The network capacity notification module 271 provides the user with the result of the multiple PDP context activation attempted in response to the user request command. The network capacity notification module 271 outputs the multiple PDP context activation result through the user interface. That is, the network capacity notification module 271 processes the information associated with the accept/reject of the network in response to the multiple PDP context activation request and notifies the user of the result. Particularly in the case that the multiple PDP context activation fails due to the incapacity of the network, the network capacity notification module 271 notifies the user of the reason for the multiple PDP context activation failure.

The table generation module 273 acquires information on whether the network supports the multiple PDP context activation function from the multiple PDP context activation response message received from the network and stores the acquired information in the memory unit 260 in the form of a table. In an exemplary implementation, the table is a network information table 265. The table generation module 273 also stores the results of the multiple PDP context activation attempted in response to the user request within the table.

The multiple PDP context determination module 275 determines whether the current network supports the multiple PDP context activation function with reference to the network information table 265, and attempts the multiple PDP context activation on the basis of the determination result. If it is determined that the current network supports the multiple PDP context activation function, the multiple PDP context determination module 275 attempts a multiple PDP context activation to the network. On the other hand, if the current network does not support the multiple PDP context activation function, the multiple PDP context determination module 275 stops the multiple PDP context activation procedure.

In the above manner, the control unit 270 controls the multiple PDP context activation with reference to the PDP context capacities of the networks so as to prevent the MS 200 from attempting the PDP context activation to the network which does not support the multiple PDP context activation capacity. Also, the control unit 270 provides the user with the PDP context capacity information of the network such that the user recognizes the cause of the PDP context activation failure intuitively.

As described above, the MS 200 according to an exemplary embodiment of the present invention is provided with at least one air communication interface. Although the example of FIG. 5 illustrates that the MS 200 is configured to support the dual mode communications for the 2G and 3G networks, the present invention is not limited to the dual mode mobile station.

Although MS 200 is schematically depicted to help in understanding the present invention, the present invention is not limited to the configuration of the mobile station depicted in FIG. 5. For example, the MS 200 may further include at least one of a camera module, an electronic accounting module, a short range communication module, an audio processing module, a digital broadcast reception module, a battery module, and their equivalents. Also, the internal components constituting the MS 200 can be omitted or replaced by other components.

Although the MS is described in association with specific communication systems, the present invention is not limited to the specific communication systems. For example, the MS can support at least one of various communications currently deployed and to be developed in the future.

The multiple PDP context activation procedure described in the above exemplary embodiments of the present invention can be applied to domestic and international roaming scenarios.

Although exemplary embodiments of the present invention are described in detail hereinabove, it should be clearly understood that many variations and/or modifications of the basic inventive concepts herein taught which may appear to those skilled in the present art will still fall within the spirit and scope of the present invention, as defined in the appended claims and their equivalents.

As described above, a PDP context management method for a mobile station according to the present invention enables the mobile station to provide the user with the PDP context capacity information of a network before attempting multiple PDP context activation to the network, whereby the mobile station initiates the multiple PDP context activation procedure reflecting a user's intention.

Also, the PDP context management method for a mobile station according to the present invention enables the mobile station to efficiently utilize the resources of networks having different PDP context capabilities and extends multiple PDP context activation function to the networks of which capabilities are changed without requiring a software upgrade, resulting in reduction of additional upgrade costs and improvement of competitiveness to other manufacturers.

Also, the PDP context management method for a mobile station according to the present invention enables the mobile station to determine multiple PDP context utilization status of networks having different PDP context capacities and manage multiple PDP context activation attempts on the basis of the PDP context capacities and PDP context utilization status of the networks, resulting in minimization of PDP context activation errors.

What is claimed is:

1. A packet service method of a mobile station, comprising:
creating a network information table after activating a packet data protocol (PDP) context to a network;
determining, when a multiple PDP context activation is requested, whether the network has a multiple PDP context capacity with reference to the network information table;
requesting, if the network has a multiple PDP context capacity, a multiple PDP context activation to the network; and
stopping, if the network does not have a multiple PDP context capacity, an attempt of a multiple PDP context activation to the network.

2. The packet service method of claim 1, wherein the determining of whether the network has a multiple PDP context capacity comprises:
determining whether information on the network exists in the network information table;
determining, if information on the network exists in the network information table, whether the network supports multiple PDP context activation on the basis of the information; and
attempting, if information on the network does not exist in the network information table, a multiple PDP context activation to the network.

3. The packet service method of claim 2, wherein the determining of whether the network supports multiple PDP context activation comprises comparing Mobile Country Code/Mobile Network Code (MMC/MNC) of the network with at least one MMC/MNC registered to the network information table.

4. The packet service method of claim 2, wherein the attempting of the multiple PDP context activation to the network comprises:
sending a multiple PDP context activation request to the network; and
determining whether the network supports the multiple PDP context activation on the basis of information contained in a multiple PDP context activation response received in response to the multiple PDP context activation request.

5. The packet service method of claim 4, wherein the determining of whether the network supports the multiple PDP context activation comprises:
determining, if the multiple PDP context activation response is a multiple PDP context activation accept message, that the network supports the multiple PDP context activation; and
determining, if the multiple PDP context activation response is a multiple PDP context activation reject message, that the network does not support the multiple PDP context activation.

6. The packet service method of claim 5, wherein the attempting of the multiple PDP context activation to the network comprises:
starting a timer with the sending of the multiple PDP context activation request;
performing, if no multiple PDP context activation response is received until the time has expired, an error handling procedure; and
updating the network information table with a result of attempting the multiple PDP context activation.

7. The packet service method of claim 2, wherein the determining of whether the network has a multiple PDP context capacity further comprises:
evaluating a first field of the network information table;
comparing, when the first field is set to a first value, a number of currently activated PDP contexts with a maximum number of PDP contexts supported by the network; and
determining, when the first field is set to a second value, that the network does not support the multiple PDP context activation.

8. The packet service method of claim 7, wherein the comparing of the number of currently activated PDP contexts with the maximum number of PDP contexts comprises:
stopping, if the number of the currently activated PDP contexts is equal to the maximum number of PDP contexts supported by the network, the multiple PDP context activation to the network and notifying that the number of the currently activated multiple PDP contexts has reached the maximum number of PDP contexts; and
comparing, if the number of the currently activated PDP contexts is less than the maximum number of PDP contexts supported by the network, a number of currently activated primary PDP contexts with a maximum number of primary PDP contexts being able to be simultaneously activated by the network.

9. The packet service method of claim 8, wherein the comparing of the number of currently activated PDP contexts with the maximum number of PDP contexts further comprises:
performing, if the number of the currently activated primary PDP contexts is less than the maximum number of the primary PDP contexts of the network, the multiple PDP context activation; and
stopping, if the number of the currently activated primary PDP contexts is equal to the maximum number of the primary PDP contexts of the network, the multiple PDP context activation and notifying that the number of the currently activated primary PDP contexts has reached the maximum number of primary PDP contexts supported by the network.

10. The packet service method of claim 7, wherein the determining of whether the network has a multiple PDP context capacity further comprises disconnecting, if it is determined that the network does not support the multiple PDP context activation, a previous connection to the network and displaying a dialog asking whether to activate another PDP context.

11. The packet service method of claim 1, wherein the requesting of the multiple PDP context activation to the network comprises:
sending a multiple PDP context activation request message containing a parameter requesting capacity information on the network; and
receiving a multiple PDP context activation response message from the network in response to the multiple PDP context activation request message.

12. The packet service method of claim 11, wherein the multiple PDP context activation response message comprises at least one of a multiple PDP context activation accept message and a multiple PDP context reject message and contains capacity information of the network.

13. The packet service method of claim 12, wherein the capacity information comprises a number of PDP contexts supported by the network and a number of primary PDP contexts simultaneously supported by the network.

14. The packet service method of claim 13, further comprising determining whether the network supports multiple PDP context activation on the basis of the capacity information and storing the capacity information in the network information table.

15. A packet service method for a mobile station, comprising:
sending, by the mobile station, a Packet Data Protocol (PDP) context activation request message to a network;
determining, if a PDP context activation response message is received in response to the PDP context activation request message, whether the PDP context activation response message contains capacity information of the network;
outputting, if the PDP context activation response message does not contain capacity information, notification of the success or failure of a PDP context activation through a user interface;
outputting, if the PDP context activation response message contains capacity information, notification of the success or failure of a PDP context activation and storing the capacity information in a network information table; and
updating the network information table by adding a result of the PDP context activation.

16. The packet service method of claim 15, wherein the PDP context activation request message contains a parameter requesting the capacity information of the network.

17. The packet service method of claim 15, wherein the PDP context activation response message contains capacity information on the PDP context activation supported by the network.

18. The packet service method of claim 17, wherein the capacity information comprises a number of PDP contexts supported by the network and a number of primary PDP contexts simultaneously supported by the network.

19. A packet service method comprising:
sending, by a mobile station, a Packet Data Protocol (PDP) context activation request message containing a parameter requesting a PDP context status to a network;
sending, by the network, a PDP context accept/reject message containing PDP context status information to the mobile station;
storing, at the mobile station, the PDP context status information from the PDP context accept/reject message transmitted by the network in a network information table; and
determining, when a multiple PDP context activation request is detected, whether to attempt a multiple PDP context activation to the network with reference to the PDP context status information of the network in the network information table.

20. The packet service method of claim 19, further comprising updating, at the mobile station, the network information table with a result of whether to attempt the multiple PDP context activation to the network.

21. The packet service method of claim 19, further comprising:
attempting, at the network if a multiple PDP context activation request message is received, the multiple PDP context activation;
sending a multiple PDP context activation accept/reject message to the mobile station containing an attempt result of the multiple PDP context activation; and
updating, at the mobile station if a multiple PDP context activation accept/reject message is received, the network information table by reflecting the attempt result.

22. The packet service method of claim 19, further comprising:
starting a timer with the sending of the multiple PDP context activation request message;
performing, if a multiple PDP context activation accept/reject message is not received before the timer has expired, an error handling procedure; and
updating the network information table with information of no reply from the network.

23. The packet service method of claim 19, wherein the PDP context status information comprises a number of PDP contexts supported by the network and a number of primary PDP contexts simultaneously supported by the network.

24. The packet service method of claim 19, wherein the determining of whether to attempt the multiple PDP context activation comprises:
determining whether the network supports the multiple PDP context activation;
stopping, if the network does not support the multiple PDP context activation, the attempt of multiple PDP context activation to the network; and
requesting, if the network supports the multiple PDP context activation, multiple PDP context activation to the network.

25. The packet service method of claim 19, wherein the network information table comprises a Mobile Country Code (MCC), a Mobile Network Code (MNC), a first field indicating the total number of PDP contexts, a second field indicating the number of Primary PDP contexts that can be simultaneously activated by the network, a third field indicating whether to support multiple PDP contexts, and a fourth field indicating whether capacity information is notified by the network.

26. The packet service method of claim 25, further comprising updating, if the network information table has the MCC and MNC of the network, the network information table with the information acquired from the network.

27. The packet service method of claim 25, further comprising updating, if the network information table does not have the MCC and MNC of the network, the network information by adding another record on the network.

28. A packet service system comprising:
a mobile station comprising a network information table containing capacity information of networks for determining whether to attempt a multiple Packet Data Protocol (PDP) context activation to a network with reference to the network information table; and
a network for sending a PDP context activation accept/reject message containing PDP context capacity information to the mobile station in response to a PDP context activation request message transmitted by the mobile station.

29. The packet service system of claim 28, wherein the PDP context activation request message comprises a parameter requesting PDP capacity information of the network.

30. The packet service system of claim 29, wherein the mobile station comprises:
a display unit for displaying information on a success/failure of PDP context activation through a user interface;
a memory unit for storing the network information table having the PDP context capacity information of at least one network; and
a control unit for controlling transmission of the PDP context activation message containing a parameter requesting the PDP context capacity of the network, for updating the network information table with the PDP context capacity information extracted from the PDP context activation response message received from the network, and for determining whether to attempt the multiple PDP context activation request on the basis of the network information table.

31. The packet service system of claim 30, wherein the control unit comprises:
a network capacity notification module for providing a user with a result of attempting the multiple PDP context activation;
a table generation module for generating the network information table with the PDP context capacity information acquired from at least one network; and
a multiple PDP context determination module for determining whether the network supports the multiple PDP context activation.

32. The packet service system of claim 31, wherein the multiple PDP context determination module attempts the multiple PDP context activation to the network supporting the multiple PDP context activation and stops attempting the multiple PDP context activation to the network which does not support the multiple PDP context activation.

33. The packet service system of claim 30, wherein the memory unit stores a network PDP context capacity notification software module, a PDP context capacity information generation and storage software module, and a multiple PDP context determination software module.

34. The packet service system of claim 28, wherein the PDP context activation accept/reject message comprises fields indicating a number of PDP contexts supported by the network and a number of primary PDP contexts simultaneously supported by the network.
